(19) United States
(12) Patent Application Publication
(10) Pub. No.: US 2008/0316230 A1
(43) Pub. Date: Dec. 25, 2008

(54) SYSTEM AND METHOD FOR SCALING NAVIGATION INFORMATION OF A USER'S SELECTION

(75) Inventor: YU-TSUNG SU, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/940,874

(22) Filed: Nov. 15, 2007

(30) Foreign Application Priority Data
Jun. 22, 2007 (CN) 200710200854.4

(51) Int. Cl. G09G 5/00

(52) U.S. Cl. 345/667

(57) ABSTRACT

A scaling system for showing navigation information on a display includes a selection module configured for selecting a target zone on the display; a scanning module configured for identifying a leftmost point, a rightmost point, an uppermost point, and a lowermost point of the target zone; a positioning module configured for positioning a midpoint of the target zone to a central point of the display; and a controlling module configured for magnifying/reducing the target zone.

### TECHNICAL FIELD

The present invention relates to methods for showing navigation information and, particularly, to a scaling method and a system for showing navigation information in a dynamic scale according of a user's selection.

### DESCRIPTION OF RELATED ART

Navigation systems, such as in-vehicle navigation systems, are well known in the art. Typically, for example, an in-vehicle navigation system consists of a console having a display screen for showing navigation information like map or other travel information to a user. Navigation information may include such items as points of interest, local restaurants, theater locations, and the like. The user operates and controls the console by inputting commands to the display to show corresponding map or other information.

Normally, a magnification function of the map is provided in the display to zoom in or out on the corresponding information. However, the magnification function is set to magnify/reduce a whole section of the map shown in the display. The user has to find his target by correspondingly moving the cursors. The operation of the navigation systems in the art is not capable of providing an instant magnification of the user's target. It is time-consuming for the user to find his target in operating the navigation system.

Therefore, it is desirable to provide a scaling system and a scaling method capable of showing instant magnification of the navigation information of a user's selection.

### SUMMARY

In accordance with one present embodiment, a scaling system for showing navigation information on a display includes a selection module, a scanning module, a positioning module, and a controlling module. The selection module is configured for selecting a target zone on the display. The scanning module is configured for identifying coordinates of the leftmost point, the rightmost point, the uppermost point, and the lowermost point of the target zone. The positioning module is configured for positioning a midpoint of the target zone according to the coordinates. The controlling module is configured for magnifying/reducing the target zone and setting to the midpoint of the target zone as a central point to display.

Other advantages and novel features will be drawn from the following detailed description of at least one preferred embodiment, when considered conjunction with the attached drawings.

### BRIEF DESCRIPTION OF THE DRAWING

Many aspects of the present scaling system for showing navigation information on a display can be better understood with reference to the following drawings. The components in the drawings are not necessarily drawn to scale, the emphasis instead being placed upon clearly illustrating the principles of the present scaling system. Moreover, in the drawings, like reference numerals designate corresponding parts throughout the several views.

FIG. 1 is a schematic functional block diagram of a scaling system for showing navigation information, according to a present embodiment.

FIG. 2 is a flow chart of a scaling method for showing navigation information, according to another present embodiment.

### DETAILED DESCRIPTION OF THE EMBODIMENTS

Embodiments will now be described in detail below, with reference to the drawings.

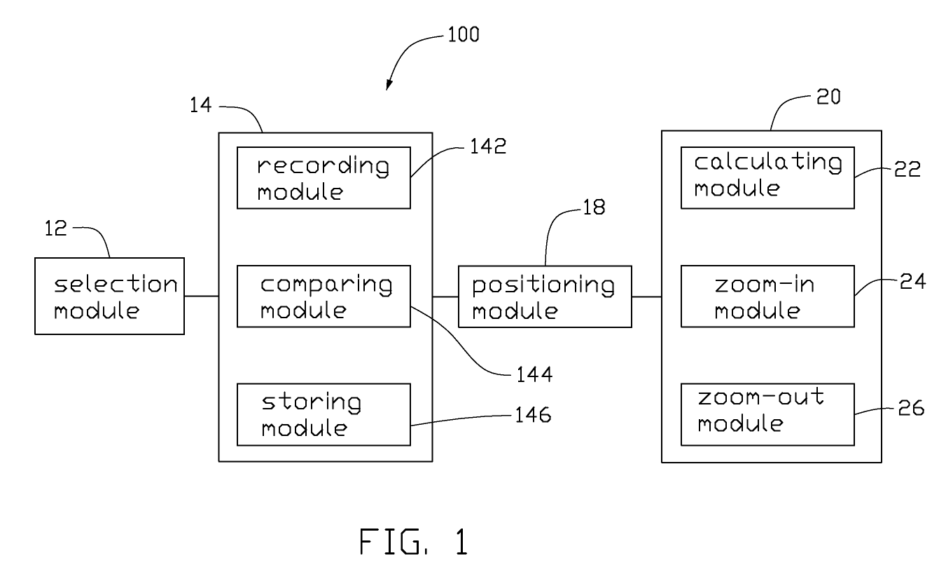

Referring to FIG. 1, a schematic functional block diagram of a scaling system 100 for showing navigation information according to a present embodiment is disclosed. The scaling system 100 includes a selection module 12, a scanning module 14, a positioning module 18, and a controlling module 20.

The selection module 12 is configured for selecting a target zone M on a display showing navigation information. The scanning module 14 includes a recording module 142, a comparing module 144, and a storing module 146. The recording module 142 is configured for identifying and recording the X and Y coordinates of each of a plurality of predetermined points located inside the target zone M. The points are predetermined according to a desired resolution and may correspond to pixels of the display. The comparing module 144 is configured for comparing between the X coordinate and the Y coordinate of each individual point inside the target zone M to find a leftmost point A, a rightmost point B, an uppermost point C, and a lowermost point D of the target zone M. The storing module 146 is configured for storing the coordinates of the leftmost point A, the rightmost point B, the uppermost point C, and the lowermost point D.

The positioning module 18 is configured for calculating the X and Y coordinates of a midpoint F of the target zone M according to the coordinates of the leftmost point A, the rightmost point B, the uppermost point C, and the lowermost point D. The X coordinate of the midpoint F is obtained by averaging the X coordinates of the leftmost point A and the rightmost point B. Similarly, the Y coordinate of the midpoint F is obtained by averaging the Y coordinates of the uppermost point C and the lowermost point D. Thus, the midpoint F of the target zone M is found by the positioning module 18.

The controlling module 20 includes a calculating module 22, a zoom-in module 24, and a zoom-out module 26. The calculating module 22 calculates a first difference (Dx1) in the X coordinates between the leftmost point A and the rightmost point B. The zoom-in module 24, using a first scale of a first predetermined length to the first difference (Dx1), magnifies the target zone M. Preferably, the midpoint F is set as a central point of the display, the zoom-in module 24 magnifies the target zone M using the first scale accordingly.

Similarly, the calculating module 22 can calculate a second difference (Dy2) in the Y coordinates between the uppermost point C and the lowermost point D. The zoom-in module 24 can magnify the target zone M, using a second scale of a second predetermined length to the second difference (Dy2). Preferably, the zoom-in module 24 magnifies the target zone M using the second scale and setting the midpoint F as the central point of the display.

The calculating module 22 can calculate a third difference (Dx3) in X coordinates between the leftmost point A and the rightmost point B of a magnified target zone M′. By setting the midpoint F as the central point of the display, the zoom-out module 26 can reduce, using a third scale of the first difference (Dx1) to the third difference (Dx3), the magnified target zone M′ thus resuming the original size.

Similarly, the zoom-out module 26 can calculate a fourth difference (Dy4) in Y-coordinates between the uppermost point C and the lowermost point D of a magnified target zone M′. The zoom-out module 26 can reduce, using a fourth scale of the second difference (Dy2) to the fourth difference (Dy4), the magnified target zone M′ thus resuming the original size.

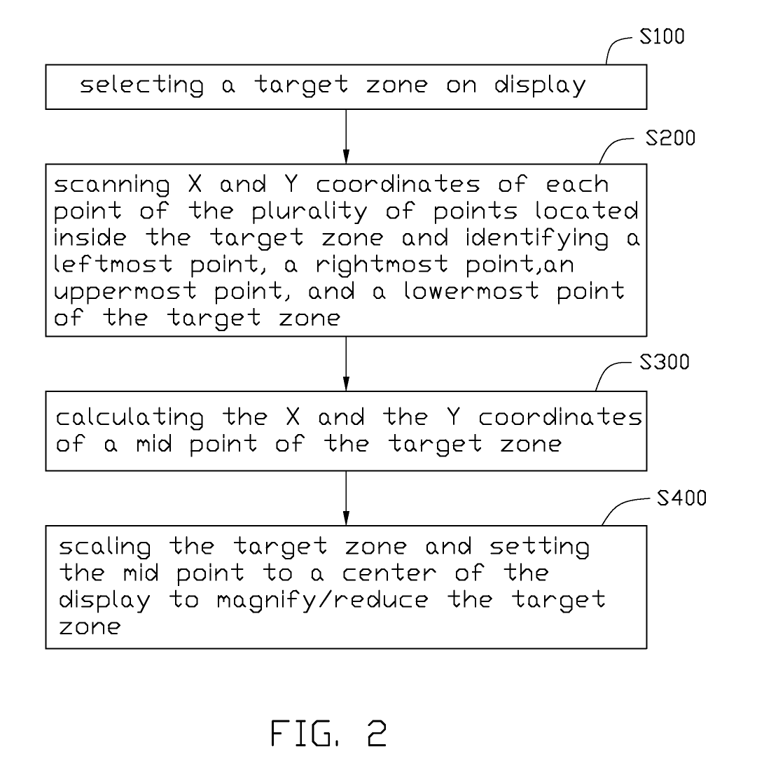

Referring to FIG. 2, a scaling method for showing navigation information according to a present embodiment is disclosed. The method includes following steps of:

S100: selecting a target zone M on the navigation information of the display;

S200: scanning the X and Y coordinates of each point of the plurality of points located inside the target zone M on the display and identifying a leftmost point A, a rightmost point B, an uppermost point C, and a lowermost point D of the target zone M;

S300: calculating the X and Y coordinates of a midpoint F of the target zone M according to the coordinates of the leftmost point A, the rightmost point B, the uppermost point C, and the lowermost point D; and

S400: scaling the target zone M and setting the midpoint F as a center point of the display to magnify/reduce the target zone M.

In step S100, the target zone M is selected on the display of the navigation system by the selection module 12. The selection module 12 is capable of receiving a selection in a selected area on the display. In this present embodiment, the selection is made by using a touch pen to delineate the target zone M on the display.

In step S200, the recording module 142 identifies X and Y coordinates of each individual point of the plurality of points located inside the target zone M. The comparing module 141 compares between the X and Y coordinates of the individual points inside the target zone M to find the leftmost point A (noted as A(xₐ,yₐ)), the rightmost point B (noted as B(x_{b},y_{b})), the uppermost point C (noted as C(x_{c},y_{c})), and the lowermost point D (noted as D(x_{d},y_{d})). The X and Y coordinates of the leftmost point A, the rightmost point B, the uppermost point C, and the lowermost point D are stored in the storing module 146.

In step S300, the positioning module 18 calculates the X and Y coordinates of the midpoint F of the target zone M according to the X and Y coordinates of the leftmost point A, the rightmost point B, the uppermost point C, and the lowermost point D. The X coordinate of the midpoint F (x_{f}) is obtained by averaging the X coordinates of the leftmost point A, (xₐ), and the rightmost point B, (x_{b}), wherein x_{f}=(xₐ+x_{b})/2. Similarly, the Y coordinate of the midpoint F (y_{f}) is obtained by averaging the Y coordinates of the uppermost point C, (y_{c}), and the lowermost point B, (y_{d}), wherein y_{f}=(y_{c}+y_{d})/2.

In step S400, the calculating module 22 calculates a first difference (Dx1) of X coordinates between the leftmost point A, and the rightmost point B, wherein Dₓ₁=x_{b}−xₐ. The zoom-in module 24 magnifies the target zone M, using a first scale of a first predetermined length to the first difference (Dx1). Preferably, the first predetermined length is a transverse length of the display. The midpoint F is set as the central point of the display, the zoom-in module 24 magnifies the target zone M using the first scale. The calculating module 22 can calculate a second difference (Dy2) in Y coordinates between the uppermost point C, and the lowermost point D, wherein d_{y2}=y_{c}−y_{d}. The zoom-in module 24 can magnify the target zone M, using a second scale of a second predetermined length to the second difference (Dy2). Preferably, the second predetermined length is a vertical length of the display. Accordingly, the zoom-in module 24 magnifies the target zone M in the second scale and sets the midpoint F as the central point of the display.

In step S400, the calculating module 22 can calculate a third difference (Dx3) in X coordinates between the leftmost point A and the rightmost point B of a magnified target zone M′. The zoom-out module 26 can reduce the magnified target zone M′, using a third scale of the first difference (Dx1) to the third difference (Dx3), thus resuming an original size on the display.

While certain embodiments have been described and exemplified above, various other embodiments will be apparent to those skilled in the art from the foregoing disclosure. The present invention is not limited to the particular embodiments described and exemplified but is capable of considerable variation and modification without departure from the scope of the appended claims.

What is claimed is:

1. A scaling system for showing navigation information on a display, the system comprising:
a selection module configured for selecting a target zone on the display;
a scanning module configured for identifying a leftmost point, a rightmost point, an uppermost point, and a lowermost point of the target zone;
a positioning module configured for positioning a midpoint of the target zone to a central point of the display; and
a controlling module configured for magnifying/reducing the target zone.

2. The scaling system as claimed in claim 1, wherein the X coordinate of the midpoint is obtained by averaging the X coordinates of the leftmost point and the rightmost point.

3. The scaling system as claimed in claim 1, wherein the Y coordinate of the midpoint is obtained by averaging the Y coordinates of the leftmost point and the rightmost point.

4. The scaling system as claimed in claim 1, wherein the central point is substantially located in the middle of the display showing the navigation information.

5. The scaling system as claimed in claim 1, wherein the scanning module comprises a recording module configured for recording the X and Y coordinates of each point of a plurality of predetermined points on the display located inside the target zone.

6. The scaling system as claimed in claim 5, wherein the scanning module comprises a comparing module configured for comparing between the X and Y coordinates of each point of the plurality of points inside the target zone to find the leftmost point, the rightmost point, the uppermost point, and the lowermost point of the target zone.

7. The scaling system as claimed in claim 6, wherein the controlling module comprises a calculating module configured for calculating a first difference in X coordinates between the leftmost point and the rightmost point.

8. The scaling system as claimed in claim 7, wherein the controlling module comprises a zoom-in module configured for magnifying the target zone, using a first scale of a first predetermined length to the first difference.

9. The scaling system as claimed in claim 6, wherein the controlling module comprises a calculating module configured for calculating a third difference in X coordinates between the leftmost point and the rightmost point of a magnified target zone.

10. The scaling system as claimed in claim 9, wherein the controlling module comprises a zoom-out module configured for reducing the magnified target zone, using a third scale of the first difference to the third difference.

11. A scaling method for showing navigation information on a display, the method comprising
selecting a target zone on the display;
scanning the X and Y coordinates of each point of a plurality of predetermined points on the display located inside the target zone and identifying a leftmost point, a rightmost point, an uppermost point, and a lowermost point of the target zone;
calculating the X and Y coordinates of a midpoint of the target zone according to the coordinates of the leftmost point, the rightmost point, the uppermost point, and the lowermost point; and
scaling the target zone and setting the midpoint as a center point of the display to magnify/reduce the target zone.

12. The scaling method as claimed in claim 1, wherein the method further comprises a step for storing the X and Y coordinates of the leftmost point, the rightmost point, the uppermost point, and the lowermost point.

13. The scaling method as claimed in claim 11, wherein the method further comprises a step for calculating the X and Y coordinates of a midpoint of the leftmost point, the rightmost point, the uppermost point, and the lowermost point.

14. The scaling method as claimed in claim 13, wherein the X coordinate of the midpoint is obtained by averaging the X coordinates of the leftmost point, and the rightmost point.

15. The scaling method as claimed in claim 13, wherein the Y coordinate of the midpoint is obtained by averaging the Y coordinates of the uppermost point, and the lowermost point.

16. The scaling method as claimed in claim 11, wherein the scaling method further comprises a step of calculating a first difference between X coordinates of the leftmost point, and the rightmost point.

17. The scaling method as claimed in claim 16, wherein the scaling method magnifies the target zone, using a first scale of a first predetermined length to the first difference.

18. The scaling method as claimed in claim 11, wherein the scaling method further comprises a step of calculating a third difference of X coordinates between the leftmost point and the rightmost point a magnified target zone.

19. The scaling method as claimed in claim 18, wherein the scaling method reduces the magnified target zone, using a third scale of the first difference to the third difference.

20. Software stored on a computer readable medium for showing navigation information on a display screen, to perform functions comprising:
selecting a target zone on the display screen;
identifying a leftmost point, a rightmost point, an uppermost point, and a lowermost point of the target zone;
relocating the displayed contents in the selected target zone in a center of the display screen; and
changing a size of the relocated target zone.
